(19) United States
(12) Patent Application Publication
(10) Pub. No.: US 2023/0319071 A1
(43) Pub. Date: Oct. 5, 2023

(54) SYSTEMS AND METHODS FOR AUTOMATED GENERATION OF PLAYBOOKS FOR RESPONDING TO CYBERATTACKS

(71) Applicant: Raytheon Company, Waltham, MA (US)

(72) Inventors: Travis Ray Durbin, Richardson, TX (US); Benjamin Sean Gothman, Richardson, TX (US); Torsten Staab, Herndon, VA (US); Daniel Scott Rose, Austin, TX (US)

(73) Assignee: Raytheon Company, Waltham, MA (US)

(21) Appl. No.: 18/110,537

(22) Filed: Feb. 16, 2023

Related U.S. Application Data
(60) Provisional application No. 63/325,239, filed on Mar. 30, 2022.

(51) Int. Cl. H04L 9/40

(52) U.S. Cl. CPC H04L 63/1416; H04L 63/1466

(57) ABSTRACT

A cyber event response playbook generation system including a data interface arranged to: i) receive, from a cyber security event and response database, a plurality of types of cyber security events and corresponding cyber security event response actions associated with each of the types of cyber security events and ii) receive, from at least one cyber security event monitor, first cyber security event data. A cyber event response playbook generator is arranged to: i) receive the plurality of types of cyber security events and corresponding cyber security event response actions from the data interface ii) receive the first cyber security event data from the data interface, iii) and automatically generate a first cyber event response playbook including one or more response actions based on the received plurality of types of cyber security events and corresponding response actions and the first cyber security event data.

### RELATED APPLICATIONS

This application claims priority to U.S. Provisional Application No. 63/325,239 filed on Mar. 30, 2022, the contents of which is included herein in its entirety.

### TECHNICAL FIELD

This application relates generally to cyberattack response systems and, more particularly, to automated generation of response playbooks to cyberattacks.

### BACKGROUND

Malware allows malicious actors and cyber attackers to remotely access systems and resources on a victim’s computer or data network. Some types of malware are launched and controlled remotely by a Command and Control (C2) server. Malware (i.e., malicious software) includes any software designed to cause disruption to a computer, server, client, or computer network, leak private information, gain unauthorized access to information or systems, deprive users access to information, or that interfere with a user’s computer security and privacy. Various types of malware exist, such as computer viruses, worms, Trojan horses, ransomware, spyware, adware, rogue software, wiper, and scareware. Other examples of cyberattacks include denial-of-service (DoS), distributed denial-of-service attacks (DDoS), domain name service (DNS) amplification, Fast-flux DNS, domain hijacking, distributed reflection denial of service (DRDoS), DNS tunneling, random subdomain attack, NXdomain attack, cache poisoning, and a zero-day attack.

Protection and recovery strategies against malware and DNS attacks can vary according to the type of malware or DNS attack. Typical protection techniques include installing antivirus software, firewalls, applying regular patches to reduce attack vectors, securing networks from intrusion, having regular backups and isolating infected systems. Certain types of malware are now being designed to evade antivirus software detection. Commercial products are available for passive network intrusion detection and defensive end-point security.

Existing cyber defense techniques and systems typically rely on the MITRE Adversarial Tactics, Techniques, and Common Knowledge (ATT&CK) framework which is a curated database and model for cyber adversary behavior that categorizes a cyber attacker’s behavior, phases of a cyberattack, and platforms that cyberattacks will target. As attack patterns evolves, the framework continues to evolve. The MITRE ATT&CK was developed in 2013 based on the results of a Fort Meade Experiment (FMX) where cyber attacker and defender behavior was emulated to improve detection and countermeasures with respect to cyber security events. The MITRE ATT&CK matrix includes a set of techniques used by cyber attackers to accomplish specific objectives. The matrix includes tactics related to enterprise networks using Window, MacOS, Linux, AWS, GCP, Azure, AD, Office 365, and SaaS. The MITRE ATT&CK framework typically requires manual mapping or integration with cybersecurity tools such as Security Information and Event Management (SIEM), Endpoint Detection and Response (EDR), and Cloud Access Security Broker (CASB).

Security Orchestration, Automation and Response (SOAR) is a collection of software programs that enable an organization to gather information about cyber security threats and respond to security events without human assistance. SOAR integrates various cyber security tools such as intrusion detection, network scanners endpoint protection software (e.g., antivirus software), firewalls, and event management (SIEM) platforms. SOAR uses data and alerts collected from the various cyber security tools and uses artificial intelligence (AI) and machines learning (ML) to automate responses to detected cyber security events. SOAR enables operators to implement playbooks that include lower-level automated actions intended to stop or mitigate a detected cyber security threat or event, such as detection and removal of malware from an organization’s network. However, SOAR is not a replacement for human analysis, but is used to augment security analyst skills and workflows. Unfortunately, SOAR is complex to deploy and manage, and still requires analysts to manually assemble playbooks which can be tedious and time-consuming. Furthermore, human development of playbooks can compromise playbook reliability due to human error during development or implementation of a playbook.

Thus, there is a need for more automated, efficient, and reliable approaches to generating and implementing playbooks for cyberattack response and defense.

### SUMMARY

The application, in various implementations, addresses deficiencies associated with current generation techniques for automated cyberattack response playbooks.

This application describes exemplary systems and methods for automated generation of cyber event response playbooks including optimized playbooks for impact (IP4) to respond to cyberattacks. Various implementations include generating cyber event response playbooks that define offensive and defensive techniques for active network defense and/or cyberattack countermeasures. The systems and methods described herein use a novel approach of automatically generating cyber event response playbooks while including operator acceptance and/or validation of generated playbooks, i.e. including a human-in-the-loop (HIL), to enhance operator assurance that a cyber event response playbook generator is creating effective and reliable cyber event response playbooks, while also continuously evolving such playbooks or developing new playbooks as cyberattacks and/or response techniques evolve.

In one aspect, a cyber event response playbook generation system includes a data interface arranged to: i) receive, from a cyber security event and response database, a plurality of types of cyber security events and corresponding cyber security event response actions associated with each of the types of cyber security events and ii) receive, from at least one cyber security event monitor, first cyber security event data. The system also includes a cyber event response playbook generator, in communications with the data interface, that is arranged to: i) receive the plurality of types of cyber security events and corresponding cyber security event response actions from the data interface ii) receive the first cyber security event data from the data interface, iii) and automatically generate a first cyber event response playbook including one or more response actions based on the received plurality of types of cyber security events and corresponding response actions and the first cyber security event data.

In one implementation, the system includes a user interface where the cyber event response playbook generator sends and/or displays a notification to an operator indicating that the first cyber event response playbook has been generated. The user may provide a report to an operator including information describing the generated first cyber event response playbook. The report may include at least one recommendation regarding a type of cyber security event response action. The type of cyber security event response action may include a type of security application to implement in response to a detected type of cyber security event of the types of cyber security events.

The operator, via a user interface, may provide an input and/or the user interface may be configured to receive a user input confirming that the first cyber event response playbook is valid to execute. The cyber security event playbook generator may store the valid first cyber event response playbook in a cyber security event playbook database. The cyber security event and response database may include a computer-readable definition of the MITRE ATT&CK framework. The at least one cyber security events monitor may include an intrusion detection system (IDS), a network scanner, endpoint protection software, antivirus software, a firewall, and/or an event management platform.

The one or more response actions of the first cyber event response playbook may include actions that augment the cyber security event response actions associated with a detected type of cyber security event of the types of cyber security events received from the cyber security event and response database. The one or more response actions of the first cyber event response playbook may include at least one action that is different than the cyber security event response actions associated with a detected type of cyber security event of the types of cyber security events received from the cyber security event and response database.

The cyber event response playbook generator may generate the first cyber event response playbook based additionally on an input from a SOAR engine. The cyber event response playbook generator may monitor the performance of the first cyber event response playbook and generate a second cyber event response playbook with improved performance with respect to the first cyber event response playbook.

In another aspect, a method for generating a cyber event response playbook includes: receiving, from a cyber security event and response database, a plurality of types of cyber security events and corresponding cyber security event response actions associated with each of the types of cyber security events; receiving, from at least one cyber security event monitor, first cyber security event data; and automatically generating, at a cyber event response playbook generator, a first cyber event response playbook including one or more response actions based on the received plurality of types of cyber security events and corresponding response actions and the first cyber security event data.

In a further aspect, a non-transient computer readable medium containing program instructions for causing a computer to generate a cyber event response playbook includes the method of: receiving, from a cyber security event and response database, a plurality of types of cyber security events and corresponding cyber security event response actions associated with each of the types of cyber security events; receiving, from at least one cyber security event monitor, first cyber security event data; and automatically generating, at a cyber event response playbook generator, a first cyber event response playbook including one or more response actions based on the received plurality of types of cyber security events and corresponding response actions and the first cyber security event data.

Any two or more of the features described in this specification, including in this summary section, may be combined to form implementations not specifically described in this specification.

The details of one or more implementations are set forth in the accompanying drawings and the following description. Other features and advantages will be apparent from the description and drawings, and from the claims.

### DESCRIPTION OF THE DRAWINGS

FIG. 1 is a block diagram of an exemplary playbook generation system within a computer network;

FIG. 2 shows a diagram of a computer system arranged to perform functions associated with generation of cyber event response playbooks;

FIG. 3 shows a block diagram of a cyber event response playbook generator;

FIGS. 4A-4B show an exemplary screen shot including a notification to an operator that a cyber event response playbook has been generated;

FIG. 5 shows an exemplary screen shot including a recommended cyber event response playbook from the cyber event response playbook generator;

FIG. 6 shows a detailed diagram of a cyber event response playbook generator; and

FIG. 7 shows a process for generating a cyber event response playbook.

Like reference numerals in different figures indicate like elements.

### DETAILED DESCRIPTION

The application, in various implementations, addresses deficiencies associated with creating playbooks for responding to cyberattacks.

Various implementations include generating cyber event response playbooks that define offensive and defensive techniques for active network defense. The systems and methods described herein use a novel approach of automatically generating cyber event response playbooks while including operator acceptance and/or validation of generated playbooks, i.e. including a HIL, to enhance operator assurance that a cyber event response playbook generator is creating effective and reliable cyber event response playbooks, while also continuously evolving such playbooks or developing new playbooks as cyberattacks and/or response techniques evolve.

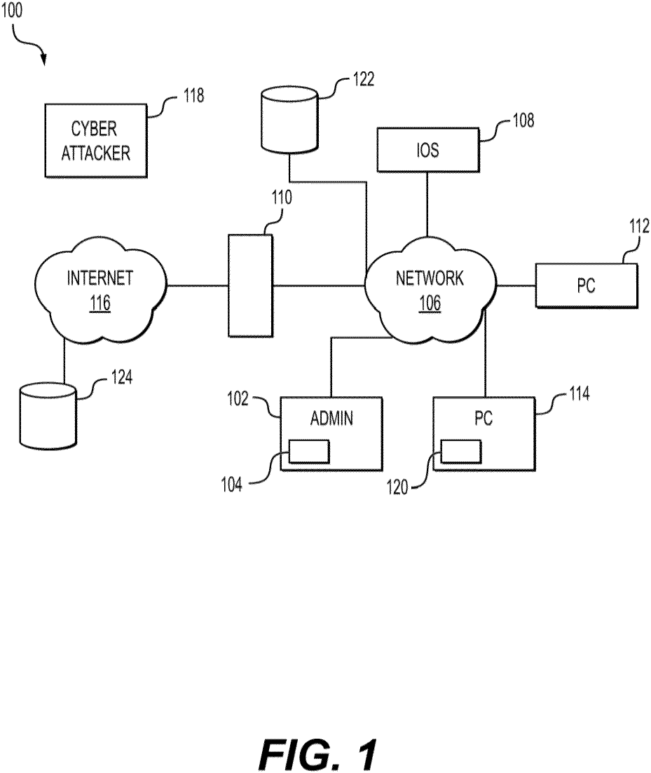

FIG. 1 is a block diagram of an exemplary computing network 100 including an enterprise network 106 connected to the Internet 116 via a gateway 110. The gateway 110 may include one or more servers and one or more firewalls. The system 100 includes a Security Operations Center (SOC) administration server 102. The SOC server 102 may include a cyber response playbook generator 104. The system 100 may include an intrusion detection system (IDS) 108, a first client computer 112, a second client computer 114, and a database 122. Client computer 114 may include a network scanner, endpoint protection software 104, e.g., an antivirus application. SOC server 102 may include a security information and event management (SIEM) system and/or SOAR engine that uses data and alerts collected from the various cyber security tools and/or cyber security event monitors, e.g., IDS 108, anti-virus application 120, and/or a firewall 110, and use AI/ML to automate responses to detected cyber security events.

Database 122, database 124, and/or SOC server 102 may include a MITRE ATT&CK framework having a curated database and model for cyber adversary behavior that categorizes a cyber attacker’s behavior, phases of a cyberattack, and platforms that cyberattacks will target. Database 122, database 124, and/or SOC server 102 may include a MITRE ATT&CK matrix having a set of techniques used by cyber attackers to accomplish specific objectives referred to as tactics. System 100 also shows a cyber attacker, C2 server, or adversary platform 118 connected to the Internet 118 from which a cyber attacker may launch cyber attacks or control malware embedded within enterprise network 106.

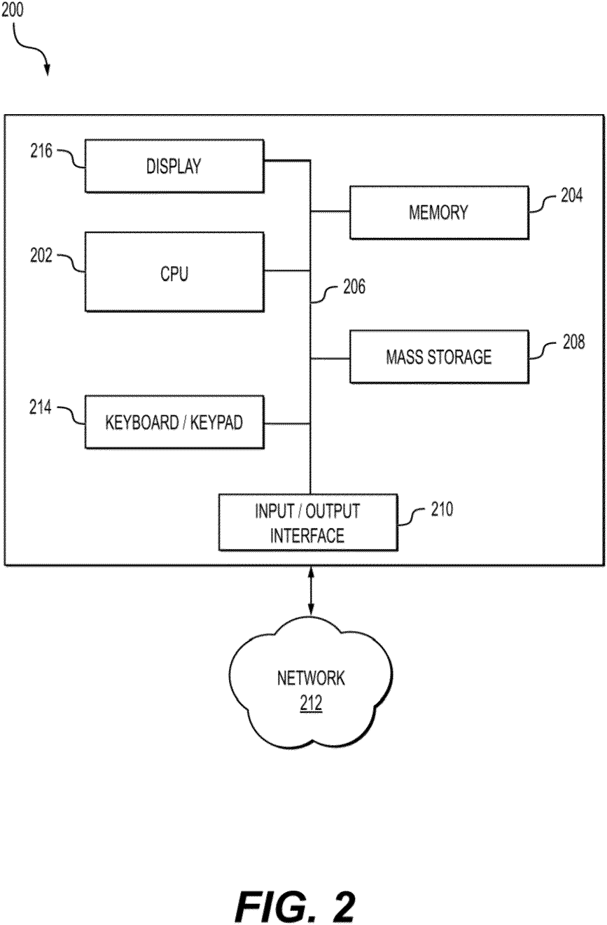

FIG. 2 shows a diagram of a computer system 200 arranged to perform functions associated with cyber event response playbook generation, including functions associated with automated playbook generation. The computer system 200 may be implemented as a virtual machine or a physical machine. The exemplary computer system 200 includes a central processing unit (CPU) 202, a memory 204, and an interconnect bus 206. The CPU 202 may include a single microprocessor or a plurality of microprocessors or special purpose processors for configuring computer system 200 as a multi-processor system. The memory 204 illustratively includes a main memory and a read-only memory. The computer 200 also includes the mass storage device 208 having, for example, various disk drives, solid state, and tape drives, etc. The memory 204 also includes dynamic random access memory (DRAM) and high-speed cache memory. In operation, memory 204 stores at least portions of instructions and data for execution by the CPU 202.

The mass storage 208 may include one or more magnetic disk, optical disk drives, and/or solid state memories, for storing data and instructions for use by the CPU 202. At least one component of the mass storage system 208, preferably in the form of a non-volatile disk drive, solid state, or tape drive, stores a database used for processing data and controlling functions of SOC server 102 and/or playbook generator 104. The mass storage system 208 may also include one or more drives for various portable media, such as a floppy disk, flash drive, a compact disc read-only memory (CD-ROM, DVD, CD-RW, and variants), memory stick, or an integrated circuit non-volatile memory adapter (i.e. PCMCIA adapter) to input and output data and code to and from the computer system 200.

The computer system 200 may also include one or more input/output interfaces for communications, shown by way of example, as interface 210 and/or a transceiver for data communications via the network 212 and/or 106. The data interface 210 may be a modem, an Ethernet card or any other suitable wired or wire-less data communications device. To provide the functions of a processor according to FIGS. 1, 3, and 6, the data interface 210 may provide a relatively high-speed link to a network 212 and/or 106, such as an intranet, internet, or the Internet, either directly or through another external interface. The communication link to the network 212 and/or 106 may be, for example, optical, wired, or wireless (e.g., via satellite or cellular network). The computer system 200 may also connect via the data interface 210 and network 212 to at least one other computer system to perform remote or distributed cyber event response playbook generation operations. Alternatively, the computer system 200 may include a mainframe or other type of host computer system capable of communications via the network 212. The computer system 200 may include software for operating a network application such as a web server and/or web client.

The computer system 200 may also include suitable input/output ports, that may interface with a portable data storage device, or use the interconnect bus 206 for interconnection with a local display 216 and keyboard 214 or the like serving as a local user interface for programming and/or data retrieval purposes. The display 216 may include a touch screen capability to enable users to interface with the system 200 by touching portions of the surface of the display 216. Server operations personnel may interact with the system 200 for controlling and/or programming the system from remote terminal devices via the network 212, Internet 116, and/or network 106.

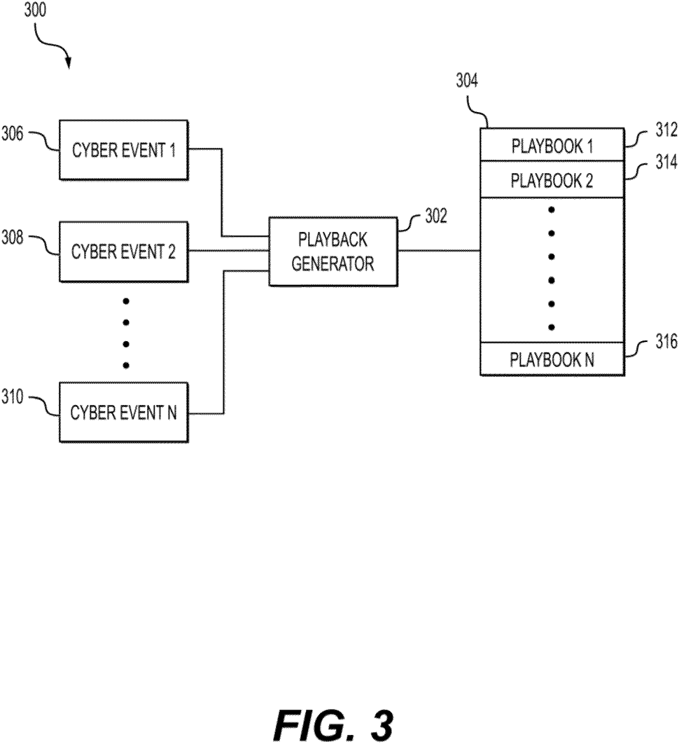

The computer system 200 may run a variety of application programs and store associated data in a database of mass storage system 208. One or more such applications may include a cyber playbook generator 104, 302, and 600 according to FIGS. 1, 3, and/or 6. The components contained in the computer system 200 may enable the computer system to be used as a server, workstation, personal computer, laptop computer, network terminal, mobile computing device, tablet, mobile telephone, System on a Chip (SoC), and the like. As discussed above, the computer system 200 may include one or more applications such as cyber event response playbook generator 104, 302, and/or 600. The system 200 may include software and/or hardware that implements a web server application.

The foregoing features of the disclosure may be realized as a software component operating in the system 200 where the system 200 includes Unix workstation, a Windows workstation, a LINUX workstation, or other type of workstation. Other operation systems may be employed such as, without limitation, Windows, MacOS, and LINUX. In some aspects, the software can optionally be implemented as a C language computer program, or a computer program written in any high level language. Certain script-based programs may be employed such as XML, WML, PHP, and so on. The system 200 may use a digital signal processor (DSP).

As stated previously, the mass storage 208 may include a database. The database may be any suitable database system, including the commercially available or open source products, such as, but not limited to, Microsoft Access, Sybase, SQL Server, MongoDB, and/or SglLite. The database can be implemented as a local or distributed database system. The database may be supported by any suitable persistent data memory, such as a hard disk drive, RAID system, tape drive system, floppy diskette, or any other suitable system. The system 200 may include a database that is integrated with server 102, cyber playbook generator 302, or cyber playbook generator 600, however, it will be understood that, in other implementations, the database and mass storage 208 can be an external element. The database may include an activity data log 602, a mapping of portion of a MITRE ATT&CK framework, legacy SOC playbooks, and/or SOAR data that are accessible by the cyber event response generator 104, 302, and/or 600, which are used to generate new playbooks or enhance existing playbooks 606 in response to detected cyberattacks.

In certain implementations, the system 200 may include an Internet browser program and/or be configured to operate as a web server. In some configurations, the client and/or web server may be configured to recognize and interpret various network protocols that may be used by a client or server program. Commonly used protocols include Hypertext Transfer Protocol (HTTP), File Transfer Protocol (FTP), Telnet, and Secure Sockets Layer (SSL), and Transport Layer Security (TLS), for example. However, new protocols and revisions of existing protocols may be frequently introduced. Thus, in order to support a new or revised protocol, a new revision of the server and/or client application may be continuously developed and released.

In one implementation, the server 102 includes a networked-based, e.g., Internet-based, application that may be configured and run on any combination of the other components of the server 102. The computer system 200 may include a web server running a Web 2.0 application or the like. Web applications running on server 102 may use server-side dynamic content generation mechanisms such, without limitation, Java servlets, CGI, PHP, or ASP. In certain embodiments, mashed content may be generated by a web browser running, for example, client-side scripting including, without limitation, JavaScript and/or applets on a wireless device.

In certain implementations, server 102 may include applications that employ Verilog HDL, VHDL, asynchronous JavaScript + XML (Ajax) and like technologies that use asynchronous loading and content presentation techniques. These techniques may include, without limitation, XHTML and CSS for style presentation, document object model (DOM) API exposed by a web browser, asynchronous data exchange of XML data, and web browser side scripting, e.g., JavaScript. Certain web-based applications and services may utilize web protocols including, without limitation, the services-orientated access protocol (SOAP) and representational state transfer (REST). REST may utilize HTTP with XML.

The SOC server 102, playbook generator 104, 302, or 600, or another component of systems connected to network 106 may also provide enhanced security and data encryption. Enhanced security may include access control, biometric authentication, cryptographic authentication, message integrity checking, encryption, digital rights management services, and/or other like security services. The security may include protocols such as IPSEC and IKE. The encryption may include, without limitation, DES, 3DES, AES, RSA, ECC, and any like public key or private key based schemes or Post Quantum Crypto (PQC) algorithms.

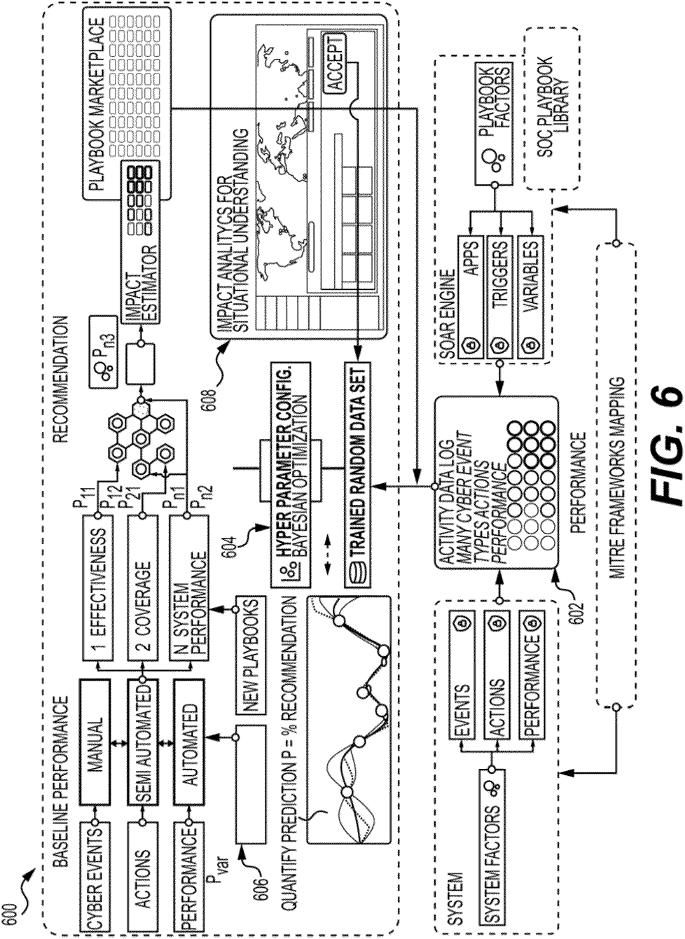

FIG. 3 shows a block diagram of cyber event response playbook generation system 300 including a cyber event response playbook generator 302. The playbook generator 302 may identify various cyber security events 306, 308, and 310 and generate corresponding cyber event response playbooks 312, 314, and 316 that are stored in a table 304 in database 122, 124, and/or SOC server 102. Playbook generator 302 may collected data from various network tools such as IDS 108, anti-virus application 120, a firewall of gateway 110 and process the collected data as, for example, activity log data 602 (see FIG. 6) to identify a cyberattack or threat. Playbook generator 302 may alternatively receive notification from a network security tool such as IDS 108 along with activity log data collected by the network security tool to use for generating playbooks 312, 314, and/or 316.

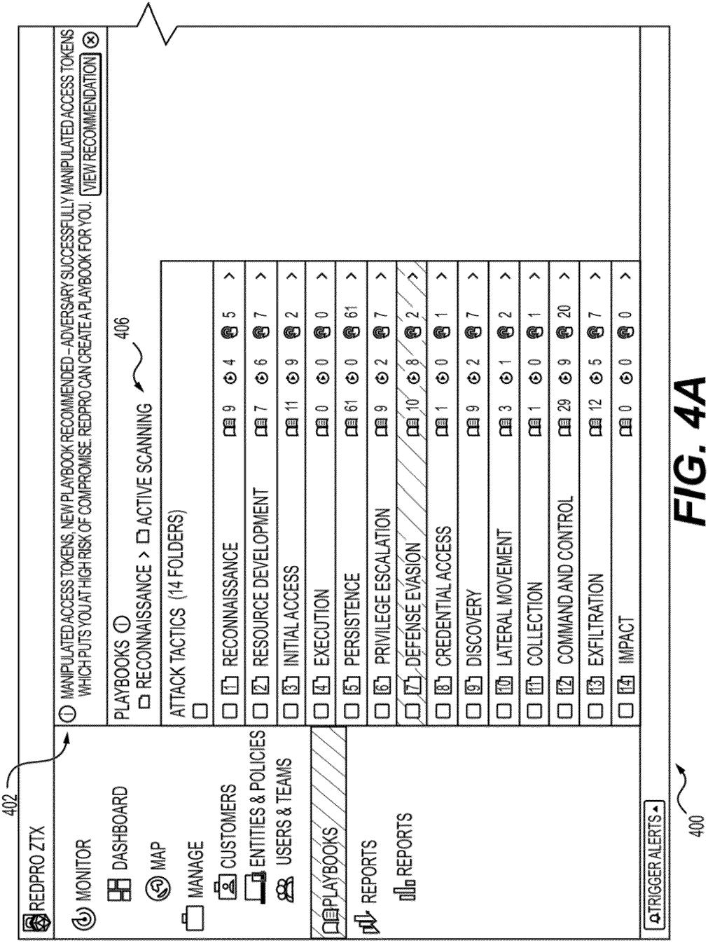

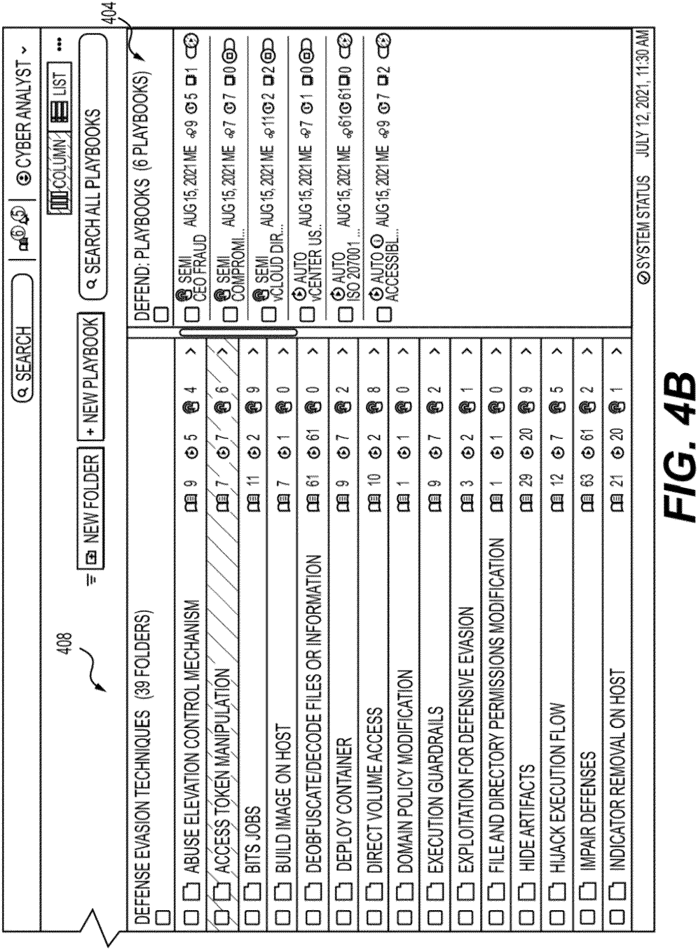

FIGS. 4A-4B show an exemplary screen shot 400 including a notification 402 to an operator that a cyber event response playbook such as playbook 312, 314, or 316 has been generated by playbook generator 104, 302, or 600. Screen shot 400 may be displayed to the operator via a user interface including, for example, display 216 of FIG. 2. Screen shot 400 also illustrates how a playbook generator 104, 302, or 600 displays additional information such as a list of attack tactics 406, defensive evasion techniques 408, and cyber event response playbooks 404.

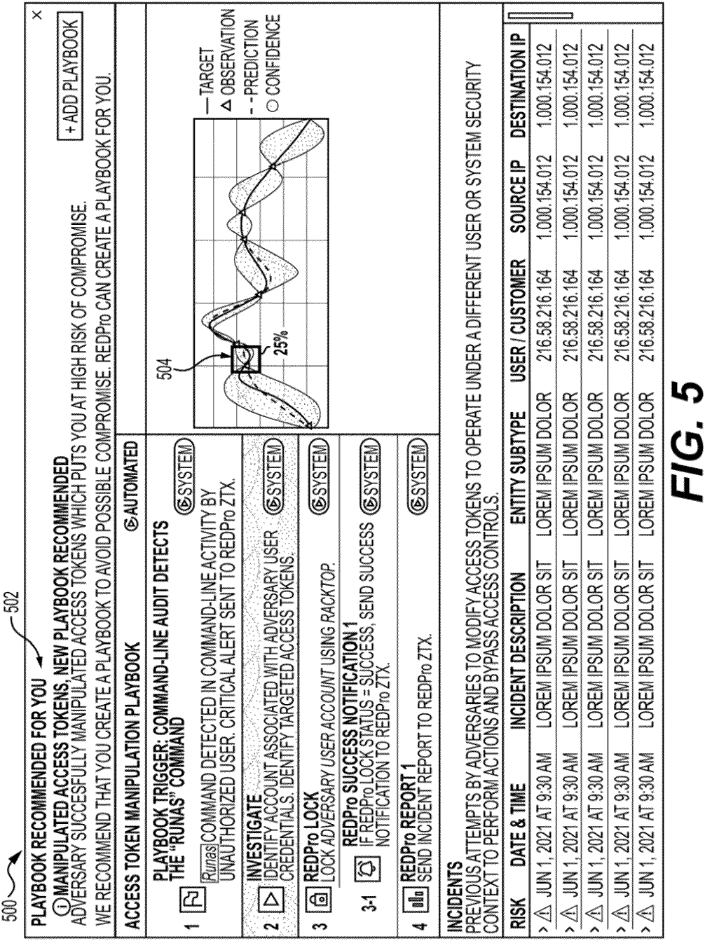

FIG. 5 shows an exemplary screen shot of a report 500 including a recommended cyber event response playbook 502 from the cyber event response playbook generator 104, 302, or 600. The report 500 also provides a graphical illustration 504 indicating that the recommended cyber response playbook 502 reduces the mean-time-to-respond (MTTR) by 25% by switching to the Racktop application. Viewing the recommendation shows details on why the playbook 104, 302, or 600 is being recommended and how it will improve MTTR for future attacks. Such information enhances the level of assurance and confidence an operator has in the ability of the playbook generator 104, 302, or 600 to develop effective cyber event response playbooks.

FIG. 6 shows a detailed block diagram of a cyber event response playbook generator 600. The generator 600 collects data from an activity data log 602 that may include cyber attack-related information from one or more cyberattack or threat detection tools and/or cyber security event monitors such as IDS 108, anti-virus software application 120, a firewall 110, a network monitor connected to network 106, among other cyberattack detection tools. Cyber event response playbook generator 600 may include or interface with a SOAR engine and MITRE ATT&CK framework. Generator 600 may include a hyper parameter configuration function that implements a Bayesian Optimization algorithm to dynamically and optimally generate new or enhance playbooks 606. Generator 600 may additionally or alternatively use one or more applications such as ML, deep learning, and Al using neural networks, or other Al and/or ML algorithms as part of the hyper parameter configuration function.

Generator 600 may provide a graphical display 608 including information regarding a recommended cyber event response playbook to an operator, i.e., a HIL, with an invitation to indicate acceptance and/or validation of the recommended playbook. In some implementation, the generator 600 may automatically validate a playbook. In certain implementations, generator 600 may generate a playbook in real-time or near real-time in response to a cyberattack. In some configurations, SOC server 102 and/or generator 102, 302, or 600 automatically executes response actions defined in a generated playbook to respond to a cyberattack.

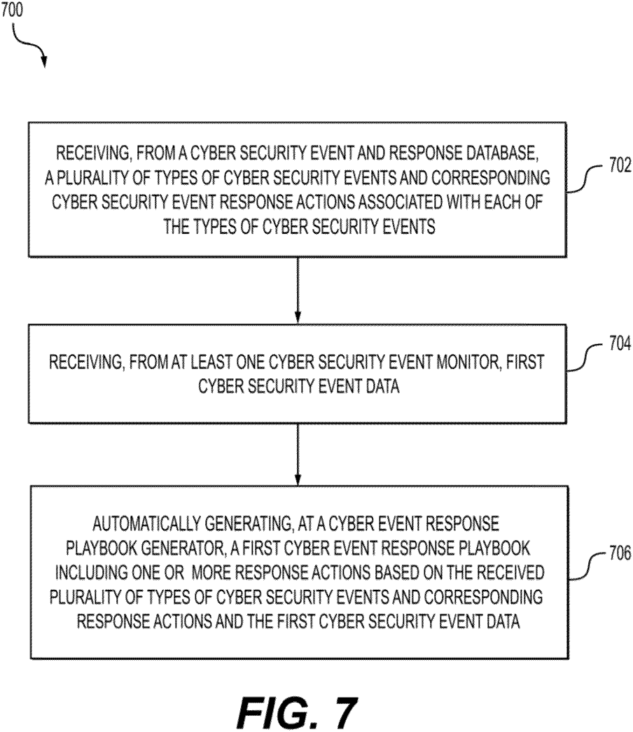

FIG. 7 shows a process 700 for generating a cyber event response playbook including: receiving, from a cyber security event and response database, a plurality of types of cyber security events and corresponding cyber security event response actions associated with each of the types of cyber security events (Step 702); receiving, from at least one cyber security event monitor, first cyber security event data (704); and automatically generating, at a cyber event response playbook generator, a first cyber event response playbook including one or more response actions based on the received plurality of types of cyber security events and corresponding response actions and the first cyber security event data (Step 706),

It will be apparent to those of ordinary skill in the art that certain aspects involved in the operation of SOC server 102, playbook generator 104, playbook generator 302, and/or playbook generator 600 may be embodied in a computer program product that includes a computer usable and/or readable medium. For example, such a computer usable medium may consist of a read only memory device, such as a CD ROM disk or conventional ROM devices, or a random access memory, such as a hard drive device or a computer diskette, SRAM or flash memory device having a computer readable program code stored thereon.

Elements or steps of different implementations described may be combined to form other implementations not specifically set forth previously. Elements or steps may be left out of the systems or processes described previously without adversely affecting their operation or the operation of the system in general. Furthermore, various separate elements or steps may be combined into one or more individual elements or steps to perform the functions described in this specification.

Other implementations not specifically described in this specification are also within the scope of the following claims.

What is claimed is:

1. A cyber event response playbook generation system comprising:
a data interface arranged to: i) receive, from a cyber security event and response database, a plurality of types of cyber security events and corresponding cyber security event response actions associated with each of the types of cyber security events and ii) receive, from at least one cyber security event monitor, first cyber security event data; and
a cyber event response playbook generator, in communications with the data interface, arranged to: i) receive the plurality of types of cyber security events and corresponding cyber security event response actions from the data interface ii) receive the first cyber security event data from the data interface, iii) and automatically generate a first cyber event response playbook including one or more response actions based on the received plurality of types of cyber security events and corresponding response actions and the first cyber security event data.

2. The system of claim 1 comprising a user interface, wherein the cyber event response playbook generator sends a notification to an operator indicating that the first cyber event response playbook has been generated.

3. The system of claim 1 comprising a user interface, wherein the cyber event response playbook generator, via the user interface, provides a report to an operator including information describing the generated first cyber event response playbook.

4. The system of claim 3, wherein the report includes at least one recommendation regarding a type of cyber security event response action.

5. The system of claim 4, wherein the type of cyber security event response action includes a type of security application to implement in response to a detected type of cyber security event of the types of cyber security events.

6. The system of claim 3, wherein the operator, via the user interface, provides an input confirming that the first cyber event response playbook is valid to execute.

7. The system of claim 6, wherein the cyber security event playbook generator stores the valid first cyber event response playbook in a cyber security event playbook database.

8. The system of claim 7, wherein the cyber security event and response database includes a MITRE Adversarial Tactics, Techniques, and Common Knowledge (ATT&CK) framework.

9. The system of claim 1, wherein the at least one cyber security event monitor includes at least one of an intrusion detection system (IDS), a network scanner, endpoint protection software, antivirus software, a firewall, and an cyber event management platform.

10. The system of claim 1, wherein the one or more response actions of the first cyber event response playbook include actions that augment the cyber security event response actions associated with a detected type of cyber security event of the types of cyber security events received from the cyber security event and response database.

11. The system of claim 1, wherein the one or more response actions of the first cyber event response playbook include at least one action that is different than the cyber security event response actions associated with a detected type of cyber security event of the types of cyber security events received from the cyber security event and response database.

12. The system of claim 1, wherein the cyber event response playbook generator generates the first cyber event response playbook based additionally on an input from a SOAR engine.

13. The system of claim 1, wherein the cyber event response playbook generator monitors the performance of the first cyber event response playbook and generates a second cyber event response playbook with improved performance with respect to the first cyber event response playbook.

14. A method for generating a cyber event response playbook comprising:
receiving, from a cyber security event and response database, a plurality of types of cyber security events and corresponding cyber security event response actions associated with each of the types of cyber security events;
receiving, from at least one cyber security event monitor, first cyber security event data; and
automatically generating, at a cyber event response playbook generator, a first cyber event response playbook including one or more response actions based on the received plurality of types of cyber security events and corresponding response actions and the first cyber security event data.

15. The method of claim 14 comprising at least one of sending a notification to an operator indicating that the first cyber event response playbook has been generated and displaying the notification to an operator indicating that the first cyber event response playbook has been generated.

16. The method of claim 14 comprising displaying a report to an operator including information describing the generated first cyber event response playbook.

17. The method of claim 16, wherein the report includes at least one recommendation regarding a type of cyber security event response action.

18. The method of claim 17, wherein the type of cyber security event response action includes a type of security application to implement in response to a detected type of cyber security event of the types of cyber security events.

19. The method of claim 14 comprising receiving from an operator an input confirming that the first cyber event response playbook is valid to execute.

20. A non-transient computer readable medium containing program instructions for causing a computer to generate a cyber event response playbook comprising the method of:
receiving, from a cyber security event and response database, a plurality of types of cyber security events and corresponding cyber security event response actions associated with each of the types of cyber security events;
receiving, from at least one cyber security event monitor, first cyber security event data; and
automatically generating, at a cyber event response playbook generator, a first cyber event response playbook including one or more response actions based on the received plurality of types of cyber security events and corresponding response actions and the first cyber security event data.
